(19) United States
(12) Patent Application Publication
(10) Pub. No.: US 2010/0050128 A1
(43) Pub. Date: Feb. 25, 2010

(54) GENERATING METHOD AND USER INTERFACE APPARATUS OF MENU SHORTCUTS

(75) Inventors: Ming-Hsiu Chiang, Taipei City (TW); Tien-Hsin Kuo, Taipei City (TW)

Correspondence Address: J C PATENTS, 4 VENTURE, SUITE 250, IRVINE, CA, 92618, US

(73) Assignee: ALI CORPORATION, Taipei City (TW)

(21) Appl. No.: 12/267,767

(22) Filed: Nov. 10, 2008

(30) Foreign Application Priority Data
Aug. 25, 2008 (CN) 200810212620.6

(51) Int. Cl. G06F 3/048

(52) U.S. Cl. 715/847

(57) ABSTRACT

A generating method and a user interface apparatus of menu shortcuts are provided. The present method is used for generating a menu shortcut list corresponding to a hierarchical content menu including a plurality of function items. When one of the function items in the content menu is selected, a frequency parameter of the selected function item is calculated and determined whether larger than a threshold. If the frequency parameter is larger than the threshold, a prompt is performed to remind the user whether to add the function item to the menu shortcut list. Then, the function item is added to the menu shortcut list according to a selecting signal input by the user. Accordingly, a process for setting the menu shortcuts can be simplified.

### CROSS-REFERENCE TO RELATED APPLICATION

This application claims the priority benefit of China application serial no. 200810212620.6, filed on Aug. 25, 2008. The entirety of the above-mentioned patent application is hereby incorporated by reference herein and made a part of specification.

### BACKGROUND OF THE INVENTION

1. Field of the Invention

The present invention relates to a method for operating a content menu. More particularly, the present invention relates to a method for generating menu shortcuts and a user interface apparatus thereof.

2. Description of Related Art

A content menu used in a current electronic product is a main entrance starting point for executing functions and changing settings. A user generally calls the content menu by pressing a “MENU” key, and controls the electronic product to execute a specific function by selecting one of the function items, in which the content menu is mainly constructed by a hierarchical structure, for example, a hierarchical content menu structure 100 shown in FIG. 1. The hierarchical content menu structure 100 includes a main directory 102, sub subdirectories 104 and 106, and function items 108.

Another method for using the product functions is to directly press a programmed key (for example, a hotkey), so as to quickly executes a desired function, and avoid wasting time for finding the desired function from the content menu layer by layer. Besides basic keys, a remote control or operating keys must have other spare keys for the hotkey utilization, and the spare keys have to be pre-programmed for executing specific functions, which is not suitable to be applied to electronic products having insufficient keys or excessive functions. Therefore, menu shortcuts are invented for resolving the above problem.

The menu shortcut is used to establish an independent list for the frequently used functions or setting pages within the content menu, by which the user can set his favourite functions or pages into a menu shortcut list. After setting of the menu shortcut list is completed, the user can recall the menu shortcut by only pressing a hotkey of the menu shortcut, and then selects a pre-edit or built-in shortcut to execute the desired function. According to such method, not only time spent on searching the content menu is shortened, but also allocation of excessive hotkeys can be avoided, and quick activating of the frequently used functions or setting pages can be achieved.

However, current menu shortcuts still have defects and improvement spaces in utilization. In detail, if list items of the menu shortcut list are preset by manufactures according to preferences of general users, such list items cannot match all of the favorite items of an individual user; and if the user can self-edit his favorite shortcut items, the user has to preset the favorite functions or pages. However, for the electronic product having complicated functions (multi-hierarchical menu structures), or an unfamiliar product or even the product used for the first time, the user probably does not know which function or page can really be a frequently used one. Therefore, the user needs some time to operate and explore the product for setting the frequently used functions and pages to the menu shortcuts, so as to enjoy advantages of the menu shortcuts. Though some users are probably accustomed to such original operating method and do not want to perform further setting, so that the menu shortcuts can be of no use.

### SUMMARY OF THE INVENTION

Accordingly, the present invention is directed to a method for generating menu shortcuts, by which a user can set a function item to be the menu shortcut according to a frequency of each function item being selected, so as to simplify a process for setting the menu shortcuts.

The present invention is directed to a user interface apparatus of menu shortcuts, which can divide a screen into a plurality of blocks according to a number of the menu shortcuts, so as to respectively display manual menu shortcuts and automatic menu shortcuts for the user to select.

The present invention provides a method for generating menu shortcuts, which is adapted to generate a menu shortcut list corresponding to a hierarchical content menu including a plurality of function items. According to the method, when one of the function items is selected, a frequency parameter of the selected function item is calculated, and whether the frequency parameter is greater than a threshold value is determined. If the frequency parameter is greater than the threshold value, a user is prompted whether to add the function item to the menu shortcut list. Next, the function item is selected to be added to the menu shortcut list according to a selecting signal input by the user.

In an embodiment of the present invention, each of the function items is set with a weight value for calculating the frequency parameter of the function item when the function item is selected. Wherein, the weight value of each of the function items is preset to 1.

In an embodiment of the present invention, the step of calculating the frequency parameter of the selected function item include accumulating a selecting times of the function item being selected within a unit time, and multiplying the selecting times by the weight value and dividing it by the unit time, so as to obtain the frequency parameter of the selected function item.

In an embodiment of the present invention, in the step of selecting to add the function item to the menu shortcut list according to the selecting signal input by the user, if the function item is not selected to be added to the menu shortcut list, the weight value of the function item is then adjusted, and the selecting times of the function item is reset for follow-up calculating the frequency parameter of the function item.

In an embodiment of the present invention, the menu shortcut list includes a plurality of menu shortcuts, and the menu shortcuts are grouped into manual menu shortcuts manually set by the user and automatic menu shortcuts added after prompting the user, in which the manual menu shortcuts are arranged in front of the automatic menu shortcuts.

In an embodiment of the present invention, the step of adding the function item to the menu shortcut list include judging whether the menu shortcut list has an empty field, in which if yes, the automatic menu shortcut corresponding to the function item is added to the field, and if not, an automatic menu shortcut not utilized for the longest time is substituted by the automatic menu shortcut corresponding to the function item.

In an embodiment of the present invention, when the menu shortcut list is judged to have no empty field, the method further includes judging whether the menu shortcut list is filled with the manual menu shortcuts, in which if the menu shortcut list is not filled with the manual menu shortcuts, the automatic menu shortcut not utilized for the longest time is substituted by the automatic menu shortcut corresponding to the function item, and if the menu shortcut list is filled with the manual menu shortcuts, generating of the automatic menu shortcut is ceased, and renewing of the frequency parameters of the function items is stopped.

In an embodiment of the present invention, when the function item is selected, the method further includes judging whether the function item is added to the menu shortcut list, and if the function item is already added to the menu shortcut list, a message is prompted for indicating that the function item is already added to the menu shortcut list.

In an embodiment of the present invention, the step of prompting whether to add the function item to the menu shortcut list includes displaying a dialog block including a prompt message indicating whether to add the function item to the menu shortcut list, and providing a plurality of prompt items for selection.

In an embodiment of the present invention, after the step of selecting to add the function item to the menu shortcut list, the method further includes activating a function corresponding to the function item.

The present invention provides a user interface apparatus of menu shortcuts, which is adapted to be disposed in an electronic product having a hierarchical content menu. The user interface apparatus includes at least one manual menu shortcut and at least one automatic menu shortcut. The manual menu shortcut is generated by selecting to set a function item of the hierarchical content menu by a user, and is displayed on a screen of the electronic product for executing a corresponding function when being selected. The automatic menu shortcut is automatically generated by the electronic product according to a frequency parameter of a selected function item of the hierarchical content menu, and is displayed on the screen for executing the function when being selected. The screen is divided into a plurality of blocks according to numbers of the manual menu shortcuts and the automatic menu shortcuts for displaying the manual menu shortcuts and the automatic menu shortcuts.

In an embodiment of the present invention, the screen is equally divided into the blocks having a number identical to the number of the menu shortcuts in a vertical direction for displaying menu shortcut names of the manual menu shortcuts and the automatic menu shortcuts.

In an embodiment of the present invention, the screen is divided into the blocks of M×N grids for displaying menu shortcut icons of the manual menu shortcuts and the automatic menu shortcuts, in which M and N are positive integers, and M×N is an positive integer greater than the number of the menu shortcuts and closest to the number of the menu shortcuts. Moreover, in another embodiment of the present invention, M is equal to N.

In an embodiment of the present invention, the user interface apparatus further includes a function block displayed on the screen, which is used for executing an operation function to the manual menu shortcuts and the automatic menu shortcuts when being selected. The operation function includes selecting, adding, erasing the manual menu shortcuts and the automatic menu shortcuts, or adjusting a display sequence of the manual menu shortcuts and the automatic menu shortcuts.

The present invention applies an automatic prompting mechanism, by which when a certain function item of the content menu is selected, whether to prompt the user to add the function item to the menu short cut list is determined according to an accumulated frequency parameter of the selected function item. Moreover, according to the present invention, the menu shortcuts manually set by the user and automatically generated by the system can be simultaneously displayed within a single user interface to facilitate the user to operate.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a conventional hierarchical content menu.

FIG. 2 is a flowchart illustrating a method for generating menu shortcuts according to an embodiment of the present invention.

FIG. 3 is a flowchart illustrating a method for generating menu shortcuts according to an embodiment of the present invention.

FIG. 4 is a flowchart illustrating a method for generating menu shortcuts according to an embodiment of the present invention.

FIG. 5 is a flowchart illustrating a method for generating menu shortcuts according to an embodiment of the present invention.

FIG. 6 is a schematic diagram illustrating a user interface apparatus of menu shortcuts according to an embodiment of the present invention.

FIG. 7 is a schematic diagram illustrating a user interface apparatus of menu shortcuts according to an embodiment of the present invention.

FIG. 8 is a schematic diagram illustrating a user interface apparatus of menu shortcuts according to an embodiment of the present invention.

FIG. 9 is a schematic diagram illustrating a user interface apparatus of menu shortcuts according to an embodiment of the present invention.

FIG. 10 is a schematic diagram illustrating a user interface apparatus of menu shortcuts according to an embodiment of the present invention.

FIG. 11 is a schematic diagram illustrating a user interface apparatus of menu shortcuts according to an embodiment of the present invention.

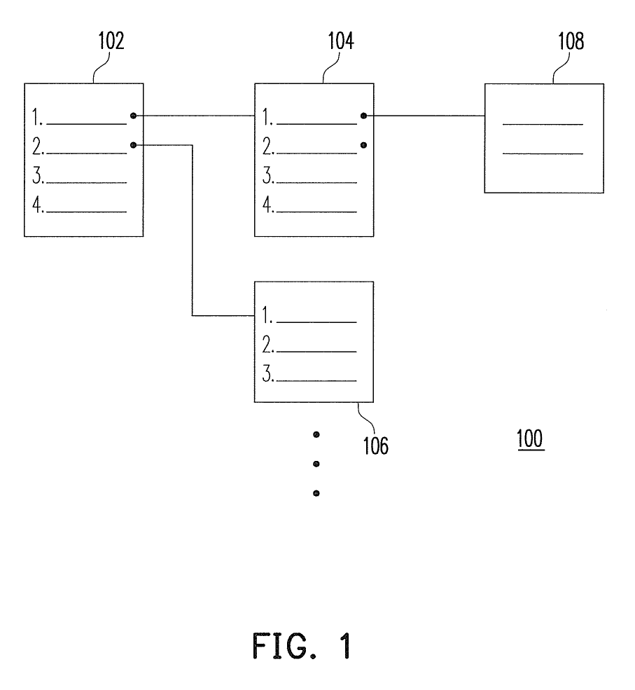

### DESCRIPTION OF EMBODIMENTS

Due to utilization defects of menu shortcuts, the present invention provides a method for automatically generating menu shortcuts and a user interface apparatus thereof, by which besides a method of manually setting the menu shortcuts is maintained, as long as a user normally operates the product, the system can prompt the user to automatically add a current function item or a setting page to the menu shortcut list via a machine learning algorithm, so as to avoid complicated steps of the manual setting and reflect real frequently used functions of the user. To fully convey the concept of the present invention, embodiments are provided below for describing the present invention in detail.

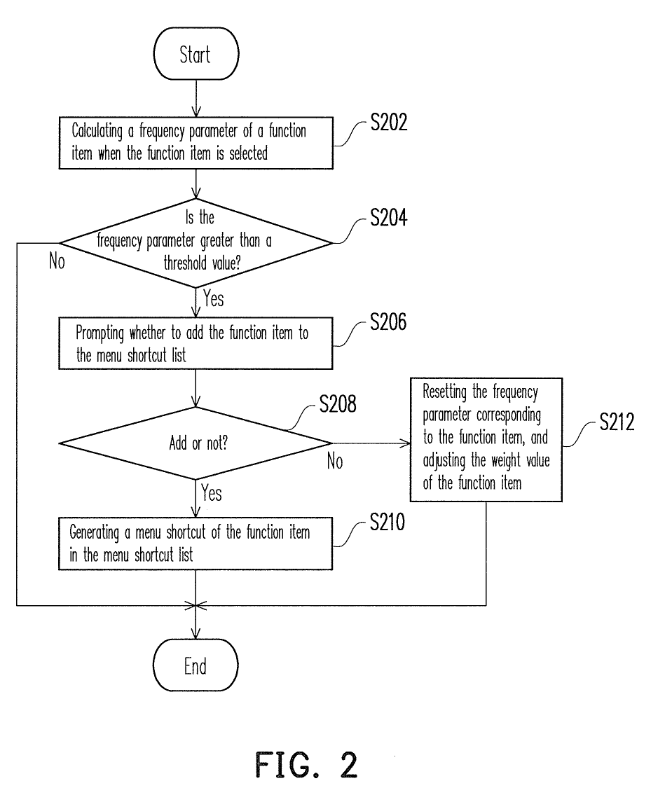

FIG. 2 is a flowchart illustrating a method for generating menu shortcuts according to an embodiment of the present invention. Referring to FIG. 2, the present embodiment is provided based on an apparatus having a hierarchical content menu structure, by which when the user operates the hierarchical content menu, a menu shortcut list corresponding to the hierarchical content menu is automatically generated, where the hierarchical content menu includes a plurality of function items. The method is described as follows.

When the user operates the hierarchical content menu, the user can enter the menu by pressing a “MENU” key for viewing and selecting the function items therein. In the present embodiment, when the user selects a certain function item, a frequency parameter of the selected function item is calculated (step S202). The function items respectively have a weight value, and when the function item is selected, the frequency parameter of the function item can be calculated with reference of the weight value. In detail, in the present embodiment, when the apparatus is activated, the weight values of all of the function items are initialized first. For the function item having the corresponding hotkey, the weight value thereof is set to be −1 for representing not to execute an automatic menu shortcut generating mechanism of the present invention to such function item; and for the function item manually added to the menu shortcut, the weight value thereof is set to be 0 for representing it is customized by the user, which means besides it is not required to execute the automatic menu shortcut generating mechanism to such function item, and the menu shortcut thereof also cannot be substituted by the automatic generated menu shortcuts. The weight values of other function items are set to be 1.

For example, a calculation method of the frequency parameter can be described as follows. First, a selecting times N of the function item being selected within a unit time t is accumulated. Next, the selecting times N is multiplied by a weight value W and is divided by the unit time t, and an obtained result (W×N/t) is regarded as a frequency parameter F of such function item.

In detail, in the present embodiment, whether to add the function item executed by the user to the menu shortcut list is determined via a machine learning algorithm, and a judgement method thereof is to calculate the frequency parameter of the selected function item, and compare it to a threshold value, so as to judge whether the frequency parameter is greater than the threshold value (step S204). If the frequency parameter of the selected function item is less than the threshold value, the process for generating the menu shortcuts is ended. Conversely, if the frequency parameter of the selected function item is greater than the threshold value, such function item is judged to be a frequently used function item, and now the user is automatically prompted whether to add the function item to the menu shortcut list (step S206). The automatic prompting method is, for example, prompting the user whether to add the function item to the menu shortcut list by displaying a dialog block, in which the dialog block includes a prompting message for prompting the user whether to add the function item to the menu shortcut list and a plurality of prompting items (for example, prompting items such as yes or no) for the user to select.

Next, the function item is selected to be added to the menu shortcut list or not to be added to the menu shortcut list according to a selecting signal input by the user (step S208). In detail, if the user selects to add the function item, the system then automatically adds the function item to the menu shortcut list (step S210). Conversely, if the use selects not to add the function item, it represents that the user considers such function item is not a favourite or frequently used function item, and now the system automatically resets the frequency parameter corresponding to such function item, and adjusts the weight value of the function item (step S212). For example, the system may reduce the weight value to serve as a basis for follow-up calculating the frequency parameter of the function item.

In detail, the menu shortcut list includes a plurality of menu shortcuts, and the menu shortcuts are grouped into manual menu shortcuts manually set by the user and automatic menu shortcuts added after prompting the user. The manual menu shortcuts are, for example, arranged in front of the automatic menu shortcuts. In the step S208, when the function item is selected to be added to the menu shortcut list, whether the menu shortcut list has an empty field is judged first. If yes, the automatic menu shortcut corresponding to the function item is added to the field, and if not, an automatic menu shortcut not utilized for the longest time is selected from the menu shortcut list and substituted by the automatic menu shortcut corresponding to the added function item. The automatic menu shortcut not utilized for the longest time is, for example, the automatic menu shortcut with a minimum frequency parameter.

It should be noted that in the present embodiment, the function item that is already familiar by the user and still not added to the menu shortcut list can be manually added to the menu shortcut list, and the weight value of the manually added function item is set to 0 for representing that such function item is customized by the user and cannot be substituted by the automatic generated menu shortcuts. Accordingly, when the menu shortcut list has no empty field, the menu shortcut list is probably filled with the manual menu shortcuts manually set by the user. According to an adding condition of the present invention, the menu shortcuts manually set by the user have the priorities, and the menu shortcuts automatically generated by the system have the sub priorities, so that when the menu shortcut is added, whether the menu shortcut list is filled with the manual menu shortcuts is judged first, and if the menu shortcut list is not filled with the manual menu shortcuts, the automatic menu shortcut corresponding to the function item then substitutes the automatic menu shortcut not utilized for the longest time. However, if the menu shortcut list is filled with the manual menu shortcuts, generating of the automatic menu shortcut is ceased, and renewing of the frequency parameters of the function items is also stopped. The automatic menu shortcut generating mechanism is re-operated until the menu shortcut list has the empty field. Namely, execution of the method for generating the menu shortcuts of the present invention is ceased, so as to avoid generating excessive prompting messages to bother the user.

According to the above description, content of the menu shortcut list is determined based on the concept that the menu shortcuts manually set by the user have the priorities, and the menu shortcuts automatically generated by the system have the sub priorities. With combination of such two approaches, flexibilities for user operation and setting the menu shortcuts are improved. In the following content, another embodiment is provided for describing a whole flowchart of the method for generating the menu shortcuts in detail.

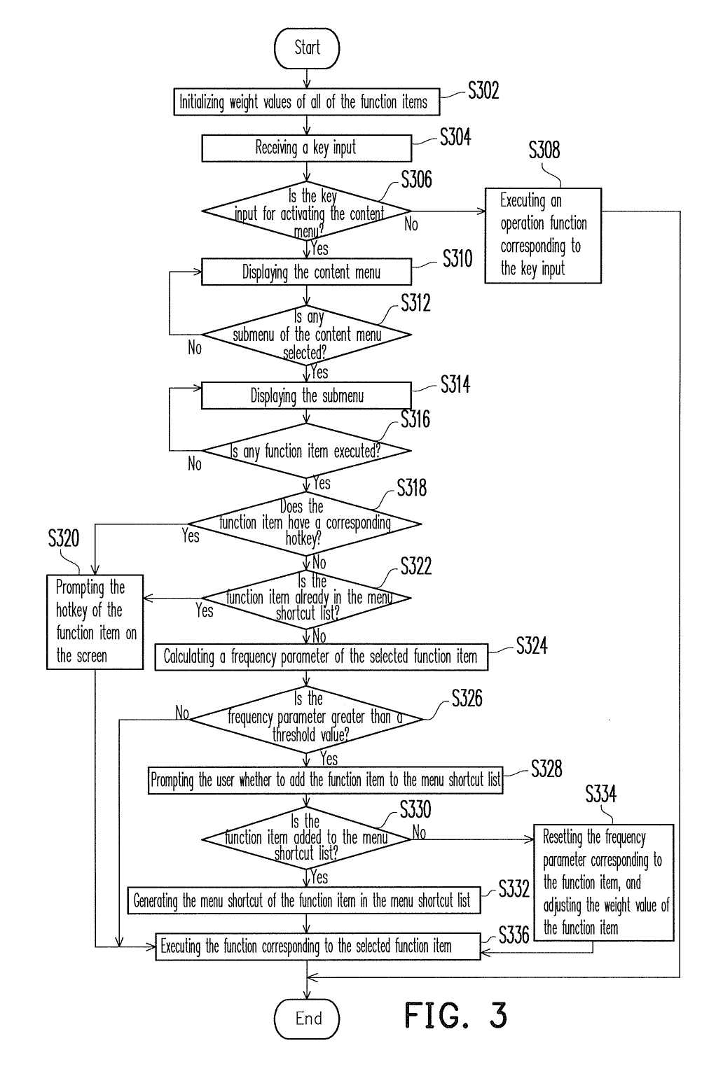

FIG. 3 is a flowchart illustrating a method for generating menu shortcuts according to an embodiment of the present invention. Referring to FIG. 3, the present embodiment is provided based on an apparatus having the hierarchical content menu structure, by which when the user operates the hierarchical content menu, a menu shortcut list corresponding to the hierarchical content menu is automatically generated, where the hierarchical content menu includes a plurality of function items. The method is described as follows.

First, the weight values of all of the function items within the hierarchical content menu are initialized (step S302). Next, a key input is received (step S304), and whether the key input is used for activating the content menu is judged (step S306). Next, if the key input is not used for activating the content menu, an operation function corresponding to the key input is executed (step S308) and the process is ended; and if the key input is used for activating the content menu, the content menu is activated and displayed (step S3 10), in which the content menu includes a plurality of submenus.

Next, whether any submenu of the content menu is selected is judged (step S312). If not, the content menu is still displayed (step S310), and if yes, the submenu is then displayed (step S314). The submenu includes a plurality of function items, and each of the function items corresponds to a function of the electronic product, for example, a media playing function, or a network function, etc.

Next, whether any function item is executed is judged (step S316). In such step, the user, for example, selects a certain function item by pressing an input key, so as to execute a function corresponding to the function item. If non function item is executed, the submenu is still displayed (the step S314). When the function item is executed, whether the function item has a corresponding hotkey is judged (step S318). If yes, the hotkey of the function item is prompted on the screen (step S320), and the function corresponding to the selected function item is executed (step S336). Conversely, if there is no corresponding hotkey, whether the function item is already in the menu shortcut list is judged (step S322).

If the function item is already existed in the menu shortcut list, the menu shortcut of the function item is then prompted on the screen (step S320), and the function corresponding to the selected function item is executed (step S336). Conversely, if the function item is not existed in the menu shortcut list, a frequency parameter of the selected function item is then calculated (step S324), and the frequency parameter is compared to a threshold value for judging whether the frequency parameter is greater than the threshold value (step S326).

If the frequency parameter of the selected function item is less than the threshold value, the function corresponding to the selected function item is directly executed (step S336); and if the frequency parameter of the selected function item is greater than the threshold value, such function item is then judged to be a frequently used function item, and now the system automatically prompts the user whether to add the function item to the menu shortcut list (step S328), and judges whether the user selects to add the function item (step S330). If the user selects to add the function item, the system automatically adds the function item to the menu shortcut list (step S332). Conversely, if the user does not select to add the function item, it represents the user considers the function is not a favourite or a frequently used one, and now the system automatically resets the frequency parameter of such function item, and adjusts the weight value of the function item (step S334). The above steps S324-S334 are the same or similar to the steps S202-S212 of the previous embodiment, and therefore detailed description thereof is not repeated.

After the function item is added to the menu shortcut list, the function corresponding to the selected function item is then executed (the step S336). By such means, while automatic generation of the menu shortcuts is implemented, the manual setting approach is still maintained, so that the method for generating the menu shortcuts of the present invention is convenient and flexible.

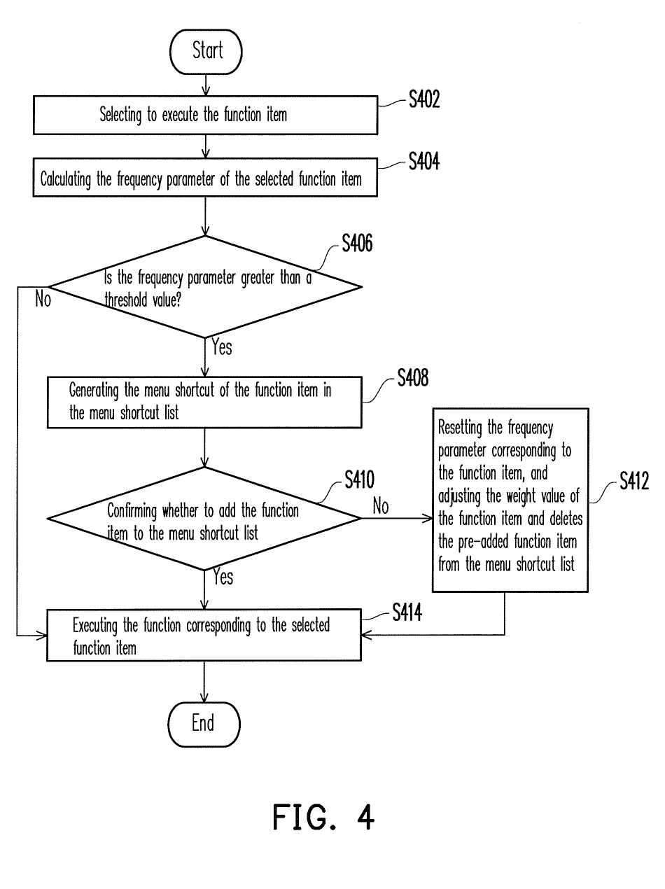

It should be noted that in an embodiment of the present invention, when the frequency parameter of the function item is greater than the threshold value, the system can automatically add the function item to the menu shortcut list, and then prompts the user for confirmation. FIG. 4 is a flowchart illustrating a method for generating menu shortcuts according to an embodiment of the present invention. Referring to FIG. 4, in the present embodiment, when the user selects to execute the function item, whether the function item is deleted is determined according to the selection of the user. The method is described as follows.

First, the user selects to execute the function item (step S402), and when the function item is executed, the system calculates the frequency parameter of the selected function item (step S404), and compares the frequency parameter with a threshold value for judging whether the frequency parameter is greater than the threshold value (step S406).

If the frequency parameter of the selected function item is less than the threshold value, the function corresponding to the selected function item is directly executed (step S414), and if the frequency parameter of the selected function item is greater than the threshold value, such function item is then judged to be frequently used one, and now the system automatically adds the function item to the menu shortcut list (step S408), and prompts the user that the function item is added. Next, the user confirms whether to add this function item (step S410).

If the user confirms to add this function item, the function corresponding to the selected function item can be executed (step S414). Conversely, if the user selects to delete the function item, the system then resets the frequency parameter of the function item and adjusts the weight value thereof, and deletes the pre-added function item from the menu shortcut list (step S412). Then, the function corresponding to the selected function item is executed (step S414). By such means, automatic generation of the menu shortcuts can also be implemented.

It should be noted that when the user operates the content menu, the system can automatically judge whether the function item currently viewed by the user is already stored in the menu shortcut list or has the corresponding hotkey. If yes, a message is prompted aside the function item for notifying the user that the function item is already in the menu shortcut list or notifying the hotkey corresponding to the function item, so as to help the user to be familiar with these “tools” for further utilization.

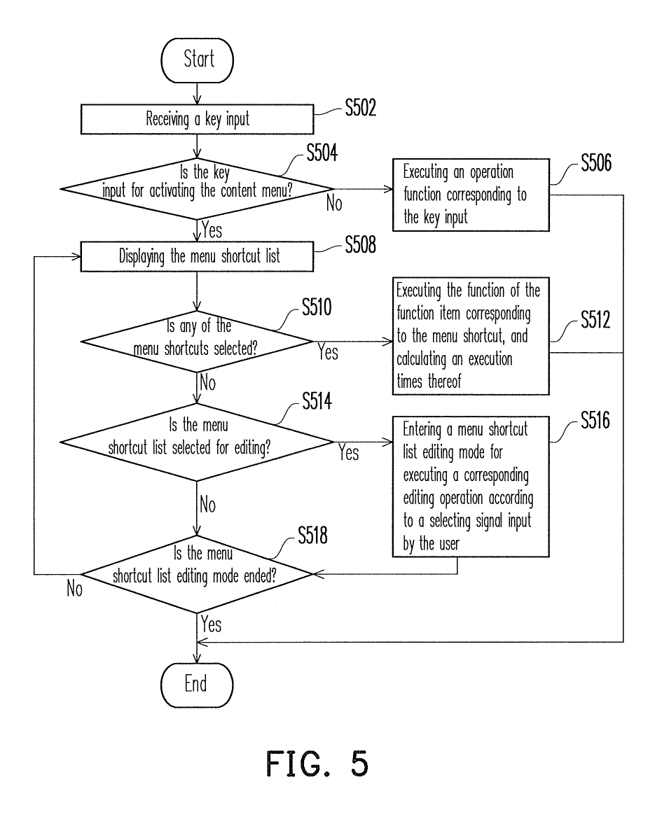

For the menu shortcut list generated according to the above method, the present invention provides a corresponding operation flow. FIG. 5 is a flowchart illustrating a method of operating a menu shortcut list. Referring to FIG. 5, in the present embodiment, how to operate the above established menu shortcut list is briefly described as follows.

First, a key input is received (step S502), and whether the key input is used for activating a key of the menu shortcut list is judged (step S504). If not, operation function corresponding to the key input is executed (step S506), and if yes, the menu shortcut list is activated and displayed (step S508), in which the menu shortcut list includes a plurality of the menu shortcuts.

Next, whether any of the menu shortcuts is selected is judged (step S510), and if yes, the function of the function item corresponding to the menu shortcut is executed, and an execution times thereof is accumulated (step S512) to serve as a basis for determining whether the function item is substituted when a new automatic menu shortcut is generated. If non menu shortcut is selected, whether the menu shortcut list is selected for editing is judged (step S514). If the menu shortcut list is selected for editing, a menu shortcut list editing mode is entered for executing a corresponding editing operation according to a selecting signal input by the user (step S516). If the menu shortcut list is not selected for editing, whether the menu shortcut list editing mode is ended is judged (step S518). If not, the step S508 is repeated for continuously displaying the menu shortcut list, and if yes, operation of the menu shortcut list is then ended.

In detail, in the step S516, the user, for example, presses a certain hotkey for resetting the menu shortcut list or clearing the whole menu shortcut list, or deleting or modifying a single menu shortcut. When the user selects to reset the whole menu shortcut list, all the settings including contents of the list and the weight values are restored to initial values thereof. When the user selects to clear up the whole menu shortcut list, only the menu shortcut list is cleared, though the learned weight values are maintained for accelerating generation of new menu shortcuts. Moreover, when the user selects to delete or modify a single menu shortcut, only the single menu shortcut is deleted or modified.

On the other hand, for the menu shortcut list generated according to the above method, the present invention also provides a corresponding user interface apparatus, and the apparatus is, for example, allocated to the electronic product having the hierarchical content menu, which can dynamically adjust display patterns of the menu shortcuts within the menu shortcut list according to numbers and types (automatic generation or manual setting) of the menu shortcuts added to the menu short cut list, so as to facilitate the user to view and operate.

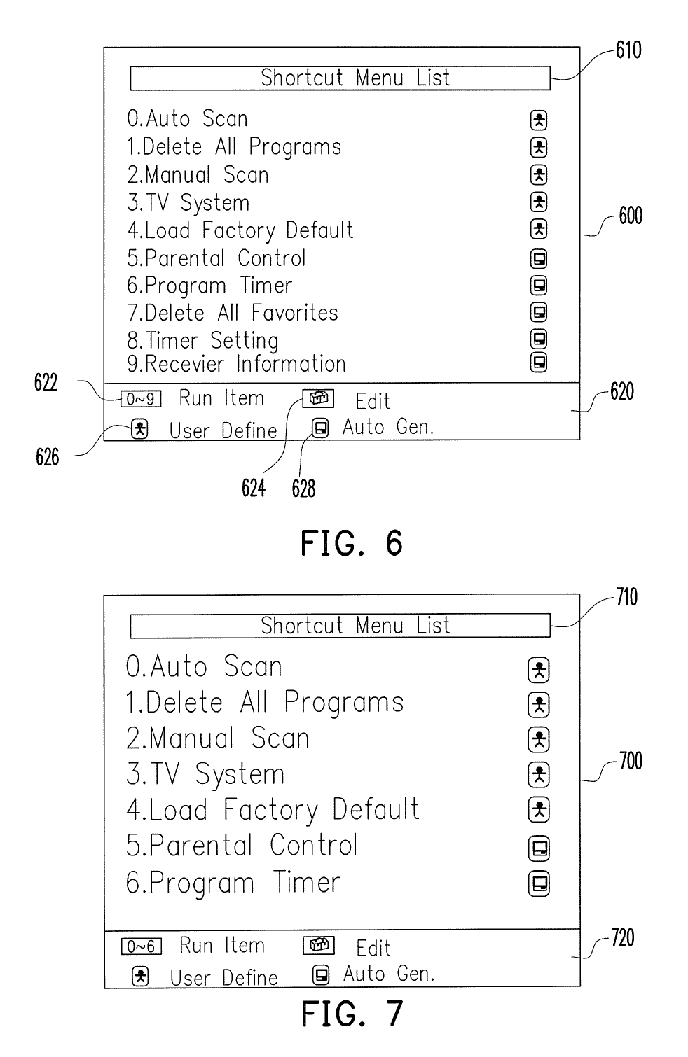

FIG. 6 and FIG. 7 are schematic diagrams respectively illustrating a user interface apparatus of menu shortcuts according to an embodiment of the present invention. Referring to FIG. 6 first, in the present embodiment, configuration of devices in the user interface apparatus of the menu shortcuts and display patterns thereof are briefly described. The user interface apparatus 600 includes a title 610, 5 manual menu shortcuts (numbered as 0-4), 5 automatic menu shortcuts (numbered as 5-9) and a function block 620, and functions thereof are described as follows.

The manual menu shortcuts (numbered as 0-4) are generated by manually setting the function items in the hierarchical content menu, which are arranged in front of the menu shortcut list in priority for executing corresponding functions when being selected.

The automatic menu shortcuts (numbered as 5-9) are automatically generated according to the frequency parameter of the selected function item of the hierarchical content menu, and generation method thereof have been described in the above embodiment, and therefore detailed description thereof is not repeated. The automatic menu shortcuts are arranged behind the manual menu shortcuts, which are also used for executing corresponding functions when being selected.

The function block 620 is displayed at the bottom of the screen for performing operation functions such as selecting, adding, modifying or deleting, etc. to the selected manual menu shortcut or the automatic menu shortcut, or adjusting a display sequence of the manual menu shortcuts and the automatic menu shortcuts. A block 622 represents that 0-9 numeral keys can be pressed to select the 0-9 menu shortcuts, a block 624 can be clicked and selected by the user to perform the editing function, a block 626 represents that the menu shortcuts marked with human icons are manual menu shortcuts, and a block 628 represents that the menu shortcuts marked with computer icons are automatic menu shortcuts, though the present embodiment is not limited thereto.

It should be noted that the user interface apparatus 600 divides the screen of the electronic product into a plurality of the blocks according to the numbers of the manual menu shortcuts and the automatic menu shortcuts, and displays a single manual menu shortcut or an automatic menu shortcut in each of the blocks. In detail, the user interface apparatus 600, for example, divides the screen of the electronic product into the plurality of blocks in a vertical direction, in which the number of the blocks is equal to a total number of the menu shortcuts, and menu shortcut names of the manual menu shortcuts and the automatic menu shortcuts are displayed in the blocks. As shown in FIG. 6, the number of the menu shortcuts is 10, so that besides the title 610 of the menu shortcut list and the function block 620 are displayed on the screen of the electronic product, the remained area of the screen is further divided into 10 blocks for respectively displaying the menu shortcuts.

Moreover, as shown in FIG. 7, the number of the menu shortcuts is 6, so that besides a title 710 of the menu shortcut list and a function block 720 are displayed on the screen of the electronic product, the remained area of the screen is further divided into 6 blocks for respectively displaying the menu shortcuts. Since the number of the divided blocks is relatively less, font of the displayed menu shortcut names is relatively large to facilitate the user to read.

On the other hand, the use interface apparatus of the present invention can also divide the screen of the electronic product into blocks of M×N grids according to the number of the menu shortcuts, so as to display menu shortcut icons of the manual menu shortcuts and the automatic menu shortcuts, in which M and N are positive integers, and M×N is an positive integer greater than the number of the menu shortcuts and closest to the number of the menu shortcuts. Moreover, M can be equal to N for dividing the screen into 9-grid.

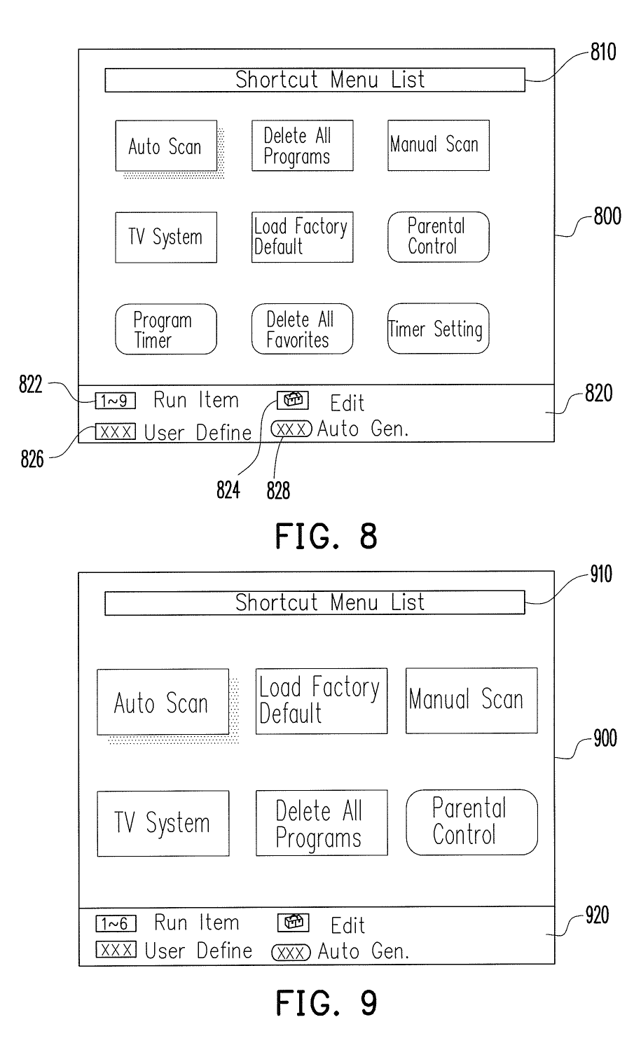

For example, FIG. 8 and FIG. 9 are schematic diagrams respectively illustrating a user interface apparatus of menu shortcuts according to an embodiment of the present invention. Referring to FIG. 8 first, besides a tile 810 and a function block 820 displayed on the screen of the electronic product, the user interface apparatus 800 of the present embodiment further divides the remained area of the screen into blocks of 3×3 grid (i.e. 9-grid), and respectively displays menu shortcut icons of 5 manual menu shortcuts and 4 automatic menu shortcuts therein. The manual menu shortcuts are represented by rectangular blocks, and the automatic menu shortcuts are represented by arc-corner blocks, and the icon having a shadow effect represents a presently viewed icon.

The function block 820 is displayed at the bottom of the screen for performing operation functions such as selecting, adding, modifying or deleting, etc. to the selected manual menu shortcut or the automatic menu shortcut, or adjusting a display sequence of the manual menu shortcuts and the automatic menu shortcuts. A block 822 represents that 1-9 numeral keys can be pressed to select the menu shortcuts of the arranged 1-9 menu shortcut icons (from the top to the bottom and from the left to the right), a block 824 can be clicked and selected by the user to perform the editing function, a block 826 represents that the menu shortcuts marked as rectangular blocks are manual menu shortcuts, and a block 828 represents that the menu shortcuts marked art-corner blocks are automatic menu shortcuts, though the present embodiment is not limited thereto.

Referring to FIG. 9 again, the user interface apparatus 900 only includes 5 manual menu shortcuts and one automatic menu shortcut, so that the screen is only divided into a 3×2 grid for displaying all of the menu shortcut icons. Since the number of the divided blocks is relatively less, the displayed menu shortcut icons are relatively large to facilitate the user to read.

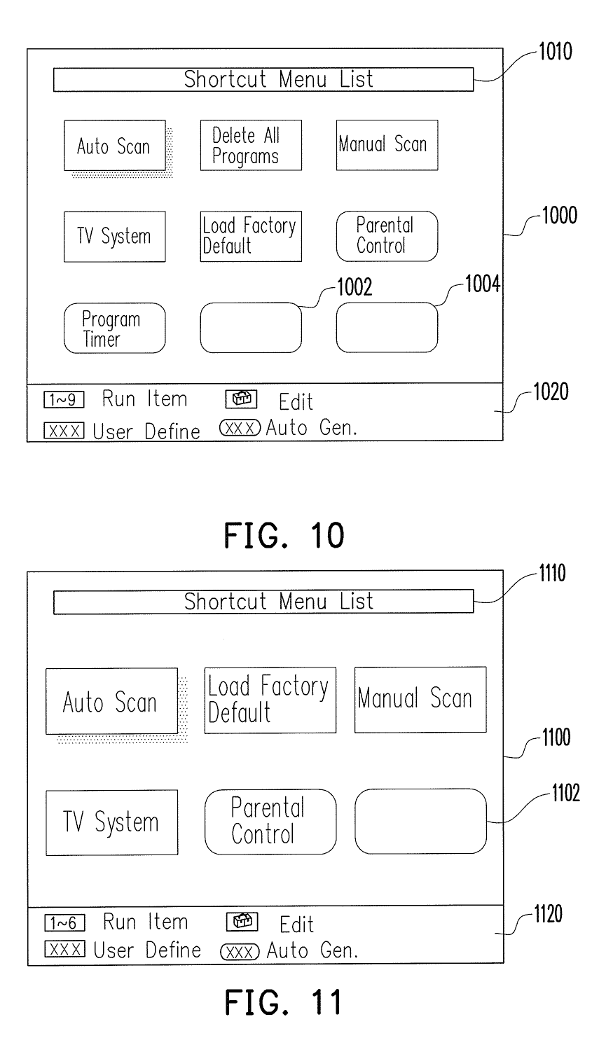

For example, FIG. 10 and FIG. 11 are schematic diagrams respectively illustrating a user interface apparatus of menu shortcuts according to an embodiment of the present invention. Referring to FIG. 10, first, besides a tile 1010 and a function block 1020 displayed on the screen of the electronic product, the user interface apparatus 1000 of the present embodiment further divides the remained area of the screen into blocks of 3×3 grid (i.e. 9-grid), and respectively displays menu shortcut icons of 5 manual menu shortcuts and 2 automatic menu shortcuts therein. The manual menu shortcuts are represented by rectangular blocks, and the automatic menu shortcuts are represented by arc-corner blocks, and the icon having a shadow effect represents a presently viewed icon. It should be noted herein that when the user interface apparatus 1000 is not filled with the menu shortcut icons of set manual menu shortcuts or automatic menu shortcuts due to the frequency parameter of the function item for setting the automatic menu shortcut still being less than the threshold, it still fills in blank shortcut icons 1002 and 1004 without showing the content so as to show the number of manual menu shortcuts that can be set by the user.

Referring to FIG. 11, the user interface apparatus 1100 only includes 4 manual menu shortcuts and one automatic menu shortcut, so that the screen is only divided into a 3×2 grid for displaying all of the menu shortcut icons. Similar to the user interface apparatus 1000, when the user interface apparatus 1100 is not filled with the menu shortcut icons of set manual menu shortcuts or automatic menu shortcuts, it still fills in a blank shortcut icon 1102 so as to show the number of manual menu shortcuts that can be set by the user.

As described above, the user interface apparatus of the present invention can dynamically adjust sizes of the displayed menu shortcut names or icons according to the number of the menu shortcuts, and can display the manual menu shortcuts and the automatic menu shortcuts by different icons or different display patterns, so as to facilitate the user to view or edit the menu shortcuts.

In summary, according to the method for generating the menu shortcuts of the present invention, each of the function items has a corresponding weight value, and selecting times thereof is recorded, so as to determine whether to prompt the user to add the function item to the menu shortcut list for simplifying a setting procedure of the menu shortcuts. Moreover, the user interface apparatus of the present invention can dynamically adjust the display patterns of the menu shortcuts according to the number of the menu shortcuts, so as to facilitate the user to view and operate the menu shortcut list.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for generating menu shortcuts, adapted to generate a menu shortcut list corresponding a hierarchical content menu having a plurality of function items, the method comprising:
calculating a frequency parameter of a function item when the function item is selected;
judging whether the frequency parameter is greater than a threshold value;
prompting whether to add the function item to the menu shortcut list if the frequency parameter is greater than the threshold value; and
selecting to add the function item to the menu shortcut list according to a selecting signal.

2. The method for generating menu shortcuts as claimed in claim 1, wherein each of the function items is set with a weight value for calculating the frequency parameter of the function item when the function item is selected.

3. The method for generating menu shortcuts as claimed in claim 2, wherein the weight value of each of the function items is preset to 1.

4. The method for generating menu shortcuts as claimed in claim 2, wherein the step of calculating the frequency parameter of the selected function item comprise:
accumulating a selecting times of the function item being selected within a unit time; and
multiplying the selecting times by the weight value and dividing it by the unit time, so as to obtain the frequency parameter of the function item.

5. The method for generating menu shortcuts as claimed in claim 4, wherein in the step of selecting to add the function item to the menu shortcut list according to the selecting signal, if the function item is selected not to be added to the menu shortcut list, the method comprises:
adjusting the weight value of the function item, and resetting the selecting times of the function item for follow-up calculating the frequency parameter of the function item.

6. The method for generating menu shortcuts as claimed in claim 2, wherein the menu shortcut list comprises a plurality of menu shortcuts, and the menu shortcuts are grouped into manual menu shortcuts manually set by the user and automatic menu shortcuts added after prompting.

7. The method for generating menu shortcuts as claimed in claim 6, wherein the manual menu shortcuts are arranged in front of the automatic menu shortcuts.

8. The method for generating menu shortcuts as claimed in claim 6, wherein the step of adding the function item to the menu shortcut list comprises:
judging whether the menu shortcut list has an empty field;
adding the automatic menu shortcut corresponding to the function item to the field if there has the empty field; and
substituting an automatic menu shortcut not utilized for the longest time within the automatic menu shortcuts by the automatic menu shortcut corresponding to the function item if there is no empty field.

9. The method for generating menu shortcuts as claimed in claim 8, wherein when the menu shortcut list is judged to have no empty field, the method further comprises:
judging whether the menu shortcut list is filled with the manual menu shortcuts;
substituting the automatic menu shortcut not utilized for the longest time within the automatic menu shortcuts by the automatic menu shortcut corresponding to the function item if the menu shortcut list is not filled with the manual menu shortcuts; and
ceasing generating the automatic menu shortcut, and stopping renewing the frequency parameter of each of the function items if the menu shortcut list is filled with the manual menu shortcuts.

10. The method for generating menu shortcuts as claimed in claim 1, wherein when one of the function items is selected, the method further comprises:
judging whether the function item is added to the menu shortcut list; and
prompting a message for indicating that the function item is already added to the menu shortcut list if the function item is already added to the menu shortcut list.

11. The method for generating menu shortcuts as claimed in claim 1, wherein the step of prompting whether to add the function item to the menu shortcut list comprises:
displaying a dialog block comprising a prompt message indicating whether to add the function item to the menu shortcut list, and providing a plurality of prompt items for selection.

12. The method for generating menu shortcuts as claimed in claim 1, wherein after the step of selecting to add the function item to the menu shortcut list, the method further comprises:
activating a function corresponding to the function item.

13. A user interface apparatus of menu shortcuts, adapted to be disposed in an electronic product having a hierarchical content menu, comprising:
at least one manual menu shortcut, generated by selecting to set a function item of the hierarchical content menu by a user, and displayed on a screen of the electronic product for executing a corresponding function when being selected; and
at least one automatic menu shortcut, automatically generated by the electronic product according to a frequency parameter of a selected function item of the hierarchical content menu, and displayed on the screen for executing the function when being selected,
wherein the screen is divided into a plurality of blocks according to numbers of the manual menu shortcuts and the automatic menu shortcuts for displaying the manual menu shortcuts and the automatic menu shortcuts.

14. The user interface apparatus of menu shortcuts as claimed in claim 13, wherein the screen is equally divided into the blocks having a number identical to the number of the menu shortcuts in a vertical direction for displaying menu shortcut names of the manual menu shortcuts and the automatic menu shortcuts.

15. The user interface apparatus of menu shortcuts as claimed in claim 13, wherein the screen is divided into the blocks of M×N grids for displaying menu shortcut icons of the manual menu shortcuts and the automatic menu shortcuts, wherein M and N are positive integers, and M×N is an positive integer greater than the number of the menu shortcuts and closest to the number of the menu shortcuts.

16. The user interface apparatus of menu shortcuts as claimed in claim 15, wherein M is equal to N.

17. The user interface apparatus of menu shortcuts as claimed in claim 15 further comprising:
a function block displayed on the screen, for executing an operation function to the manual menu shortcuts and the automatic menu shortcuts when being selected.

18. The user interface apparatus of menu shortcuts as claimed in claim 17, wherein the operation function comprises selecting, adding, erasing the manual menu shortcuts and the automatic menu shortcuts, or adjusting a display sequence of the manual menu shortcuts and the automatic menu shortcuts.
